(19) United States
(12) Patent Application Publication
(10) Pub. No.: US 2008/0100677 A1
(43) Pub. Date: May 1, 2008

(54) INK DELIVERY AND COLOR-BLENDING SYSTEM, AND RELATED DEVICES AND METHODS

(76) Inventor: Alan H. Boyer, Spofford, NH (US)

Correspondence Address: FISH & RICHARDSON PC, P.O. BOX 1022, MINNEAPOLIS, MN, 55440-1022, US

(21) Appl. No.: 11/554,298

(22) Filed: Oct. 30, 2006

(51) Int. Cl. B41J 2/17

(52) U.S. Cl. 347/84

(57) ABSTRACT

An ink supply system includes a first ink supply module configured to store a first ink, a second ink supply module configured to store a second ink, and an ink pathway configured to transfer predetermined volumes of the first and second inks from the first and second ink supply modules to a print head. The ink pathway is configured to mix and in some instances heat the predetermined volumes of the first and second inks as the inks are transferred to the print head to form a mixed ink.

### TECHNICAL FIELD

This description relates to printing devices, and to related devices and methods.

### BACKGROUND

Some radiation-curable, e.g., UV-curable, jetting inks are liquid at room temperature. To ensure correct jetting viscosity, those liquid radiation-curable inks are often jetted above room temperature, e.g., 30° C. or more, e.g., 40° C. Such inks can be jetted onto substantially non-porous substances, e.g., plastic pen barrels or circuit boards, or porous substrates. When such liquid radiation-curable inks are jetted onto a substrate, e.g., paper or plastic, to form an image, phenomena such as bleed-through, pinhole wetting and fisheyes due to the wetting characteristics of the liquid can result in inadequate ink coverage and overall poor print quality. One solution that is often used to reduce wicking is to treat the substrate to make it less porous. However, some inks do not perform well with such treatments. Another solution to minimizing wicking and bleed-through is to rapidly surface cure the ink, but often this does not completely eliminate wicking and bleed-through, and can require cumbersome and expensive equipment.

“Hybrid-F” radiation-curable jetting inks, i.e., those that polymerize by radical and/or cationic mechanisms to give polymer networks, are often described as “semi-solid inks,” and are more viscous at room temperature than at jetting temperature. Hybrid-F inks are available from Aellora™, e.g., under the tradename VistaSpec™ HB. Typically, these inks are jetted at elevated temperatures, e.g., above 60° C. or above 65° C., to lower ink viscosity to an appropriate jetting viscosity. After jetting hybrid-F ink, e.g., through a piezoelectric drop-on-demand inkjet printhead, ink viscosity rapidly increases as the ink cools on contact with the substrate. Once cooled to about room temperature, the hybrid-F ink does not flow without shear, allowing “wet-on-wet” printing without intermediate curing stages. Since the hybrid-F ink does not substantially flow at room temperature, wetting defects can be reduced, often reducing or eliminating the need for substrate surface treatments.

Liquid and hybrid-F radiation-curable inks typically contain inhibitors, e.g., hydroquinone (HQ) or hydroquinone monomethyl ether (MEHQ), which help to stabilize the ink, e.g., inhibit premature polymerization of the ink. Premature polymerization is problematic since it can clog small and delicate ink flow pathways and/or jetting nozzles within a print engine. While many inhibitors require the presence of oxygen to be effective, anaerobic inhibitors are also available that do not require the presence of oxygen to be effective.

Regarding the use of such inks in printing, inkjet printers are among the most common type of printers in use. Inkjet printing is a non-impact method of printing, wherein the ink is emitted from nozzles on a printhead as the printhead passes over a substrate. Typically, the printhead scans the substrate in one direction as the substrate is fed in a direction perpendicular to the movement of the printhead, whereby a strip of an image is printed as an array of individual pixels, which are deposited with each pass of the printhead.

Generally, for creating color, inkjets printers closely position different amounts of key primary colors on a substrate, which, from extended distances, merge to form any color under a process known as dithering. More specifically, inkjets printers typically employ inks made of what are referred to as the primary substractive colors, i.e., cyan, yellow, magenta and black (CYMK). The primary colors are dithered to form the entire color spectrum. Dithering breaks a color pixel into an array of dots so that each dot is made up of one of the basic colors (or otherwise left blank).

In binary color printing, perhaps the simplest type of color printing, the cyan, yellow, magenta, and black dots are either printed or not printed, with no intermediate choices. Thus, if the printed ink dots are mixed together (i.e., deposited adjacent or within close proximity to each other) to make intermediate colors, a binary CYMK printer can only produce eight possible color variations (cyan, yellow, magenta, red, green, blue, black, and white).

An alternative to binary color printing is halftone color printing, in which a printhead's dot resolution (measured in dots per inch) is divided into a grid of halftone cells, each cell including a varying number of dots. By controlling the combination of cells containing different proportions of CYMK dots, halftone printing fools the human eye into seeing a palette of millions of colors.

Another emerging method of color printing is six-color process printing which adds orange and green to the traditional CYMK. This six-color process offers finer color graduations than standard CYMK schemes. However, it should be noted that color printing is not limited to the traditional four and six-color processes discussed above, i.e. other combinations of colors may be used, e.g., three-color printing with primary subtractive colors: cyan, magenta and yellow (CMY).

### SUMMARY

In one aspect, a method of mixing inks includes conveying a predetermined volume of a first ink along a first conduit from a first ink supply to an ink pathway. A predetermined volume of a second ink is conveyed along a second conduit to the ink pathway. The first and second inks are conveyed through the ink pathway to a print head, and the first ink and the second ink are mixed together as they are conveyed through the ink pathway to form a mixed ink upstream of the print head (i.e., prior to jetting).

In another aspect, a method of mixing inks includes conveying a predetermined volume of a first ink along a first conduit from a first ink supply to a mixing station. A predetermined volume of a second is conveyed along a second conduit from a second ink supply to the mixing station. The first ink and the second ink are mixed at the mixing station to form a mixed ink prior to jetting, and the mixed ink is conveyed from the mixing station to a print head along an ink pathway.

According to another aspect, a method of mixing inks includes conveying a predetermined volume of a first ink along an ink pathway from a first ink supply to a print head. A predetermined volume of a second ink is conveyed along an ink conduit from a second ink supply to a first portion of the ink pathway upstream from the print head, and the first and second inks are mixed in the first portion of the ink pathway to form a mixed ink prior to jetting.

In yet another aspect, an ink supply includes a first ink supply module configured to store a first ink, a second ink supply module configured to store a second ink, and an ink pathway configured to transfer predetermined volumes of the first and second inks from the first and second ink supply modules to a print head. The ink pathway is configured to mix the predetermined volumes of the first and second inks as they are transferred to the print head to form a mixed ink prior to jetting.

Preferred implementations may include one or more of the following additional steps and/or features. The ink pathway can include a first portion configured to maintain the mixed ink below a first temperature. The ink pathway can include a second portion, downstream of the first portion, configured to heat the mixed ink above the first temperature as it is conveyed through the second portion. Methods of mixing ink can include heating the mixed ink as it is conveyed through the second portion such that substantially no thermal polymerization of the mixed ink occurs during the heating in the second portion. Methods of mixing ink can include heating the ink in the second portion, wherein a residence time of the mixed ink being conveyed through the second portion is less than 60 minutes. In some cases, the residence time of the ink being conveyed through the second portion is less than 30 minutes. The ink pathway can include a second portion, downstream from the first portion, configured to heat the mixed ink as the mixed ink is conveyed through the second portion such that substantially no thermal polymerization of the mixed ink occurs during the heating in the second portion. The first and/or second ink can be a solid granule powder, a semi-solid ink or a liquid ink. Methods of mixing inks can include heating the mixed ink in a second portion of the ink pathway downstream from the first portion. The first and/or second ink can include solid granules, and heating the mixed ink can include melting the solid granules of the first and/or second ink. The first ink can include solid granules including a first colorant, and the second ink can include solid granules including a second colorant different from the first colorant, and heating the mixed ink can include melting the solid granules of the first and second inks to achieve a blended color. The first and/or second ink can include a microwave energy absorbing material, and heating can be performed with microwave energy. Heating of inks can be performed with ultrasound. In some cases, the heating is performed with a thin-walled heat exchanger. Heating can be performed with microwave energy. Heating can be performed with a PTC thermistor. Heating can be performed by addition of a chemical material to the first and/or second ink. The ink can include an electrically conductive material, and the heating can be performed using an electrical current. Heating can be performed with a moving heat source. Heating can be performed with a resistive material. Heating can be performed with a fluid directed proximate the ink pathway. Heating can be performed by friction. The mixed ink can be heated to a second temperature that is greater than 50° C. The second temperature can be greater than 70° C. The heating of the mixed ink can be performed progressively such that a temperature of the ink increases as the ink travels through the second portion. The first ink can include a first colorant and the second ink can include a second colorant different from the first colorant, and mixing the first and second inks can include mixing the first and second inks in proportionate volumes to achieve a predetermined color. The first ink can be conveyed along the first conduit with vacuum pressure. The first and second inks can be conveyed through the ink pathway with vacuum pressure. The first and second inks can be conveyed through the ink pathway pneumatically. The first ink can be conveyed along the first conduit pneumatically. The first and/or second inks can be conveyed through the ink pathway peristaltically, e.g., with a peristaltic pump. The first ink and/or second ink can be conveyed by gravity. In some cases, the first and/or second ink is conveyed thermally, e.g., by a thermal gradient and/or by thermal expansion of the ink. In such cases, conveyance of the first ink and/or second ink can be at least partially controlled with a check valve. Mixing of inks can be performed with an auger. Mixing of the inks can be performed with a static mixer. The first ink can be conveyed along the first conduit with a recirculating ball-chain. The first and/or second inks can be conveyed through the ink pathway with a recirculating ball-chain. The first and/or second ink can include a radiation-curable material. The radiation that cures the radiation-curable material can be ultra-violet light. A wavelength of the ultraviolet light that cures the radiation-curable material can be between about 200 nm and about 400 nm. The radiation that cures the radiation curable material can be visible light. The radiation that cures the radiation-curable material can be provided by an electron beam device. The radiation-curable material can include a cross-linkable material, such as a cross-linkable monomer and/or oligomer. The cross-linkable monomer can include diacrylates, diarylates, or mixtures thereof. The cross-linkable monomer can include (2-hydroxyethyl)-isocyanurate triacrylate, dipentaerythritol pentaacrylate, ethoxylated trimethylolpropane, triacrylates, propoxy glyceryl triacrylate, propoxylated pentaerythritol tetraacrylate, or mixtures thereof. The first and/or second ink can include wax or resin. The first and/or second ink can include a polymerization inhibitor, such as hydroquinone. The first temperature can be less than about 25° C. The first temperature can less than about 0° C. The ink pathway can be permeable to air. The first portion can be chilled below room temperature with a chiller.

The details of one or more embodiments are set forth in the accompanying drawings and the description below. Other features and advantages will be apparent from the description and drawings, and from the claims.

### DESCRIPTION OF DRAWINGS

FIG. 1A is a schematic view of an ink supply system, including first and second ink supply modules.

FIG. 1B is a perspective view of the first and second ink supply modules of FIG. 1A.

FIG. 1C is a perspective view of the printing module of FIG. 1A.

FIG. 1D is a perspective view of an alternative embodiment of the first and second ink supply modules of FIG. 1B.

FIGS. 2-4 are schematic views of alternative embodiments of the ink supply system of FIG. 1A.

FIGS. 5 and 6 are perspective front and back views of a printhead, respectively.

FIG. 7 is a detailed perspective view of a printhead.

Like reference symbols in the various drawings indicate like elements.

### DETAILED DESCRIPTION

Generally, devices and methods are described that utilize ink handling systems in which in the systems can mix two or more inks prior to jetting.

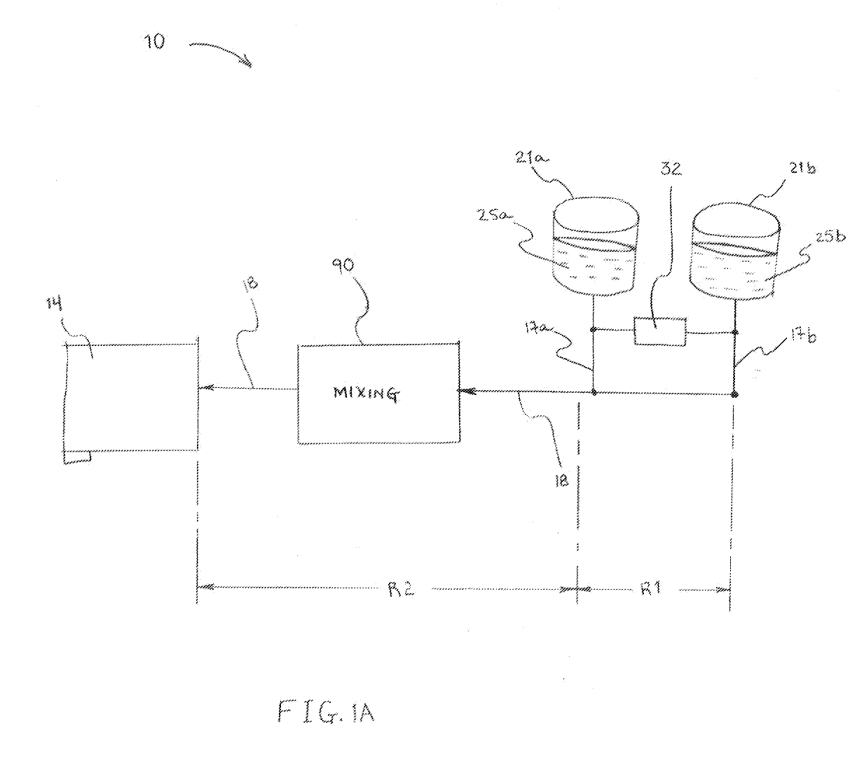

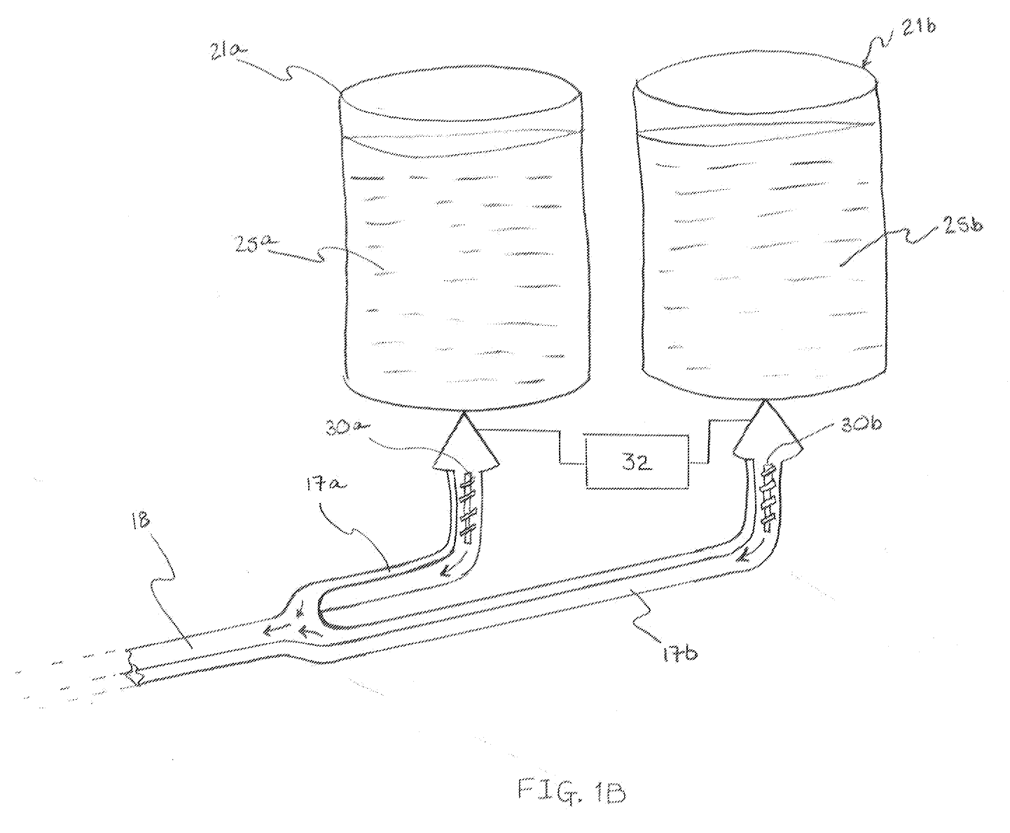

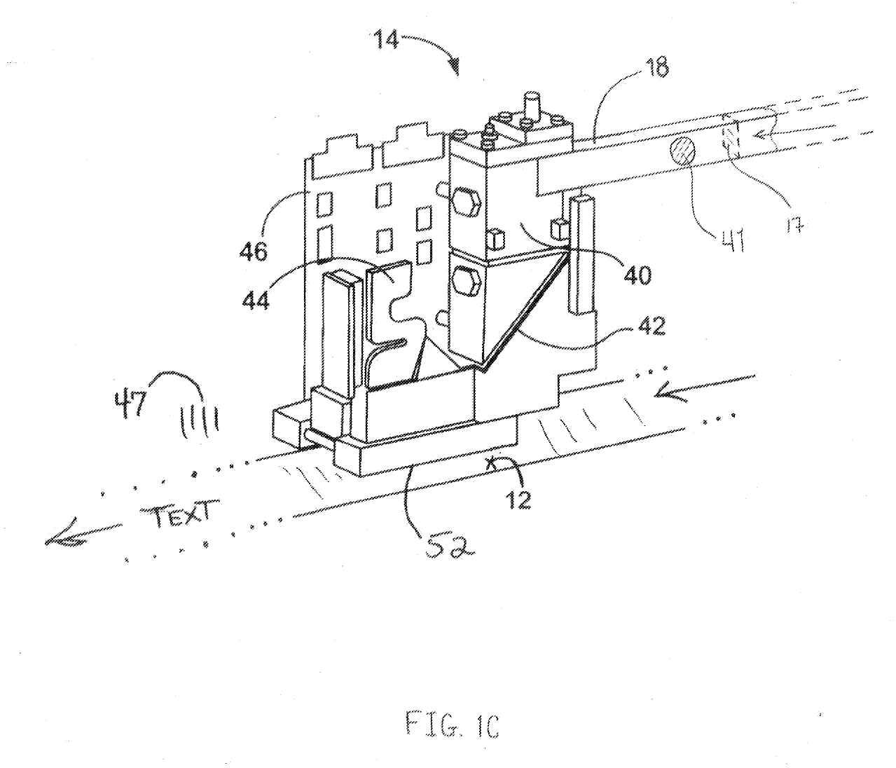

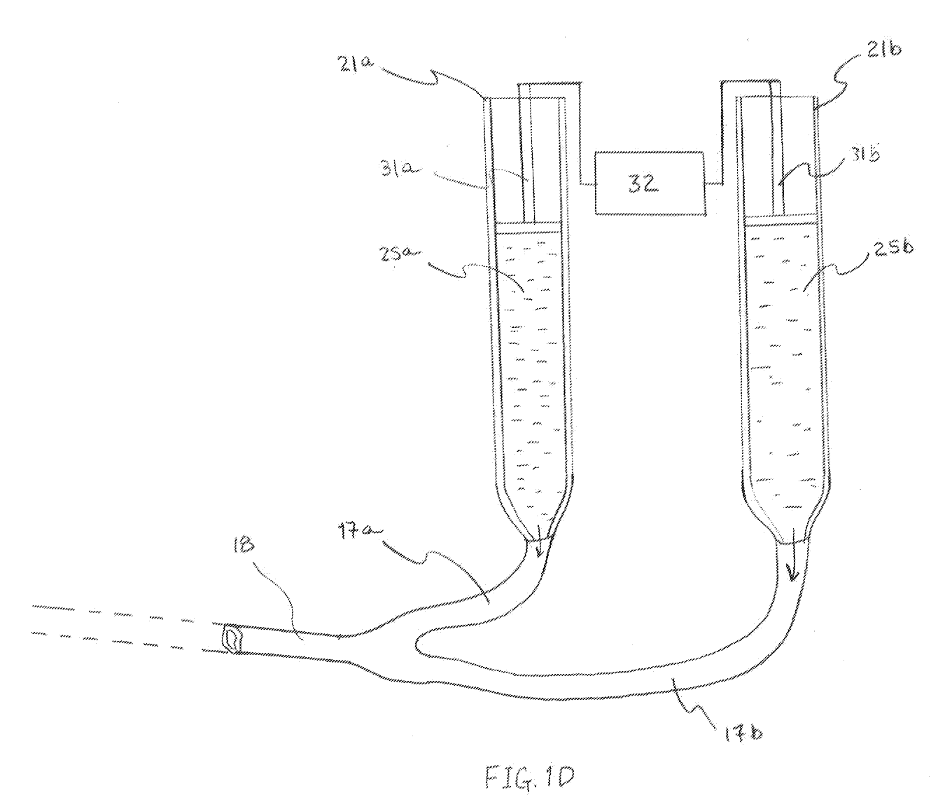

Referring to FIGS. 1A-1D, an ink supply system 10 includes first and second ink supply modules 21a, 21b and a printing module 14 that is configured to jet a radiation-curable ink. An ink pathway 18 provides a connection between the first and second ink supply modules 21a, 21b and the printing module 14 which allows for the conveyance of ink from the ink supply modules 21a, 21b to the printing module 14. The ink pathway 18 is configured to mix a first ink 25a, from the first ink supply module 21a, with a second ink 25b, from the second ink supply module 21b, in desired proportions to form a mixed ink. The ink pathway 18 includes a first region R1 and a second region R2 downstream of the first region R1. The first region R1 includes first and second ink conduits 17a, 17b. The first ink conduit 17a is configured to convey a predetermined volume of the first ink 25a from the first ink supply module 21a to the second region R2, and the second ink conduit 17b is configured to convey a predetermined volume of the second ink 25b from the second ink supply module 21b to the second region R2 where it is mixed with the predetermined volume of the first ink 25a. Mixing 90 of the first and second inks 25a, 25b can be achieved, e.g., by dispersion, diffusion, and/or mechanical induction.

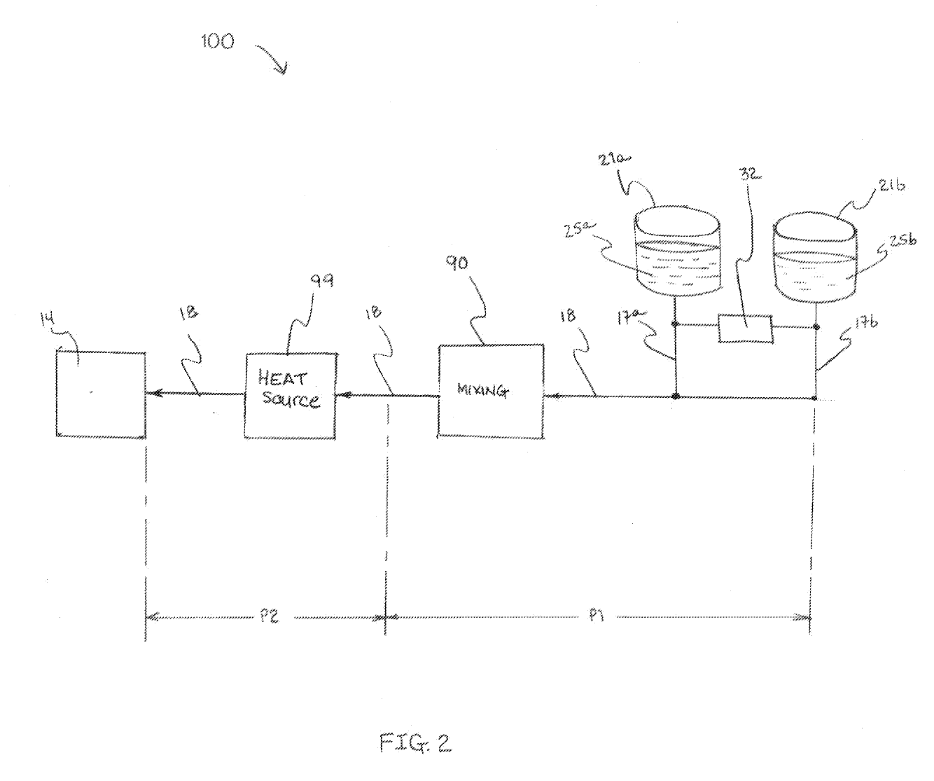

FIG. 2 shows another embodiment of an ink supply system 100 including an ink, the ink pathway 18 that is divided into two portions: a first portion P1 configured to mix the desired proportions of the first and second inks 25a, 25b; and a second portion P2, downstream of the first portion P1, that is configured to heat the mixed ink above a first temperature T₁ (i.e., a temperature of the ink exiting the first portion P1) as it is conveyed to the printing module 14. More specifically, the mixed ink is heated in the second portion P2 of the ink pathway 18 using a heat source 99 as it is conveyed from the first portion P1 to the printing module 14. For example, in some implementations, the heat source 99 can include an ink transfer heater such as an aluminum plate-and-frame heat exchanger, disposed along the ink pathway 18 in a position between the first portion P1 and the print module 14. In some instances, the first temperature T₁ is less than 50° C., e.g., less than 40° C., less than 30° C., less than 25° C., less than 15° C., or less than 5° C. In some cases, the first portion P1 of the ink pathway 18 is configured to maintain the ink(s) (e.g., the first ink, the second ink and/or the mixed ink) below the first temperature T₁. In some embodiments, the second portion P2 of the ink pathway 18 heats the ink to at least about 35° C. above the first temperature T₁, e.g., at least 50° C. above T₁, at least 75° C. above T₁ or at least about 100° C. above first temperature T₁.

During conveyance of the mixed ink through the second portion P2, little thermal polymerization of polymerizable ink components occurs during heating. In some implementations, substantially no thermal polymerization of polymerizable components of the ink occurs during conveyance of the ink through the second portion P2, e.g., less than 0.05 percent by weight, e.g., less than 0.01, less than 0.005, less than 0.001, or less than 0.0001 percent by weight. Any thermal polymerization during conveyance of the ink can block ink flow pathways, nozzles, valves and/or filters, leading to a reduction in print quality.

Generally, the first temperature T1 is chosen, e.g., such that little or no thermal polymerization occurs in the first portion P1 while the ink passes through the first portion.

Ink pathway 18 can be formed of a permeable material to allow for oxygenation of the mixed inks. In particular implementations, ink pathway 18 can include disks 41 (FIG. 1C) or other shapes or tubing made from a semi-permeable material, e.g., expanded fluoropolymer material, along the length of the pathway 18. The semi-permeable nature of the disk prevents ink from escaping from the ink pathway 18, but allows oxygen to pass through. Oxygen works in combination with inhibitors to reduce instabilities, e.g., premature thermal polymerization of ink components in the ink pathway 18. In addition, ink pathway 18 can include filters 17 (FIG. 1C), e.g., screen-type filters or sintered-type filters. Such filters can remove dust, debris and gels from the ink which can block ink pathways, nozzles, valves and/or filters, leading to a reduction in print quality. Such filters can also be located at other suitable locations along the ink flow pathways.

FIG. 3 illustrates another embodiment of an ink supply system 110 wherein heating 90 and mixing of first and second inks 25a, 25b take place concurrently as the inks 25a, 25b are conveyed along the ink pathway 18. For example, in some embodiments, a heated liquid (e.g., water, not shown) surrounds the ink pathway 18 to heat the mixed ink above a first temperature T1 as it is conveyed to the printing module 14. Alternatively, electric resistance heating elements 112 can be applied around the ink pathway 18 to heat the mixed ink as it is conveyed to the printing module 14.

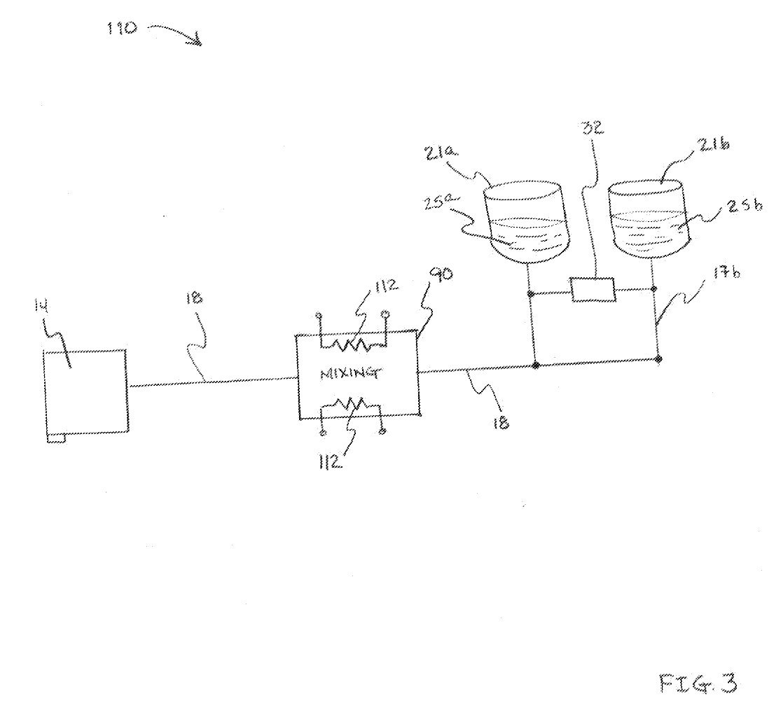

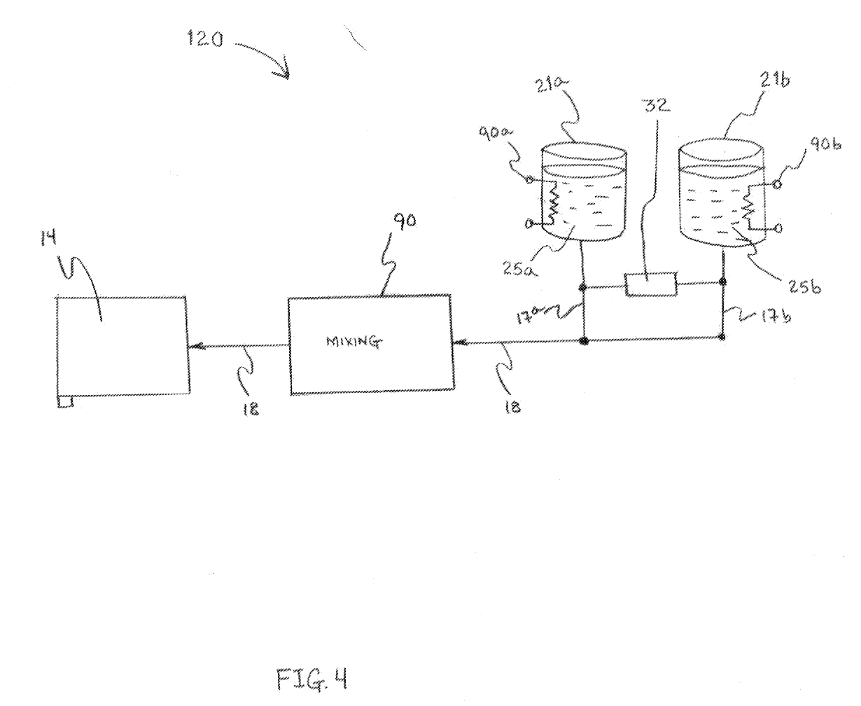

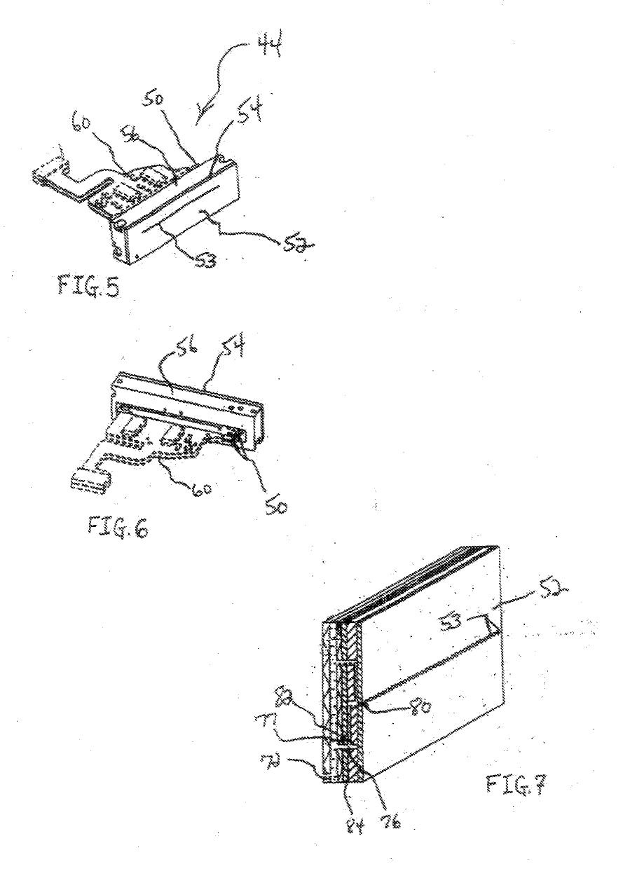

FIG. 4 illustrates yet another embodiment of an ink supply system 120 wherein the first and second inks 25a, 25b are individually heated while contained within the respective ink supply modules 21a, 21b. For example, the first and second ink supply modules can include integral heating elements 90a, 90b, respectively, for heating the first and second inks 25a, 25b within the respective ink supply modules 21a, 25b.

In the embodiment of FIG. 1A, first and second inks 25a, 25b are conveyed from the first and second ink supply modules 21a, 21b through the respective ink conduits 17a, 17b. Although only two supply modules 21a, 21b are depicted, any number of supply modules are contemplated. FIG. 1B illustrates one method for conveying the inks from the supply modules 25a, 25b to the first and second ink conduits 17a, 17b, respectively, utilizing auger screws 30a, 30b. Controller 32 manages the direction of rotation and the rotational speed of each of the screws 30a, 30b, thereby controlling the volume and flow rate of each of the inks 25a, 25b being conveyed to the second region R2 of the ink pathway. In this manner, the volumetric make-up of the mixed ink can be controlled. Thus, an ink of a particular color or hue can be created on demand (i.e., as needed) by blending two or more inks (of differing color) in accordance with the system depicted in FIG. 1. In addition, inks having various physical properties can be mixed together to achieve a mixed ink having a unique physical make-up. Referring now to FIG. 1C, after exiting the ink pathway 18, the ink is delivered to a reservoir 40 in printing module 14, where the temperature of the ink is maintained at a suitable jetting temperature, e.g., greater than 75° C.

FIG. 1D illustrates an alternative method for conveying ink utilizing a piston-cylinder positive displacement mechanism. As shown in FIG. 1D, each of the first and second ink supply modules 21a, 21b include a piston-cylinder positive displacement mechanism. Controller 32 manages the displacement of each of the pistons 31a, 31b, thereby controlling the volume and flow rate of each of the inks 25a, 25b being conveyed to the second region R2 of the ink pathway.

Various means of conveyance are available, for example, the inks can be conveyed; pneumatically, e.g., a positive displacement pump can be employed to deliver the first and second inks from the first and second ink supply modules (as shown in FIG. 1D); with vacuum pressure; the inks can be conveyed by gravity; or thermally, e.g., via thermal expansion and controlled through a check valve; or mechanically, e.g., via a recirculating ball-chain, a peristaltic pump, or auger screw (as shown in FIG. 1B).

In some instances, as described in greater detail above, the ink can be pre-heated along the ink pathway 18 prior to entering the reservoir 40, such that an ink temperature exiting the ink pathway 18 is within 15°°C. of ink residing in the reservoir 40. This minimizes the possibility that the ink in reservoir 40 is thermally shocked by the ink entering from the ink pathway 18. The ink then travels along flow path 42 to printhead 44. Controller 46 controls the jetting of ink onto substrate 12, which is traveling below the printhead 44.

Ink drop ejection is controlled by pressurizing ink with an actuator, which may be, for example, a piezoelectric actuator, a thermal bubble jet generator, an electrostatically deflected element, or a valve mechanism. Typically, printhead 44 has an array of ink paths with corresponding nozzle openings and associated actuators, such that drop ejection from each nozzle opening can be independently controlled. U.S. Pat. No. 5,265,315 describes a printhead that has a semiconductor body and a piezoelectric actuator. Piezoelectric inkjet printheads are described in U.S. Pat. Nos. 4,825,227, 4,937,598, 5,659,346, 5,757,391, and in U.S. Patent Application No. 2004/0004649. Ink on substrate 12, e.g., in the form of text or graphics, is cured with a radiation source 47, e.g., ultra-violet light or e-beam radiation. If UV radiation is used to cure the radiation-curable material, a wavelength of the light that cures the radiation-curable material is between about 200 nm and about 400 nm, e.g., a typical output from a medium pressure, metal-doped lamp, e.g., an iron-mercury lamp.

With renewed reference to FIG. 2, first and second inks 25a, 25b in first and second ink supply modules 21a, 21b, respectively, are maintained at about 25° C. in first portion P1, and then heated in second portion P2 so that the ink (i.e., the mixed ink) is approximately 75° C. when it exits the second portion P2 and enters the reservoir 40 on printing module 14.

Referring now to FIGS, 5, 6 and 7, a more detailed description of the operation of a piezoelectric printhead 44 is provided. Piezoelectric inkjet printhead 44 includes jetting modules 50 and an orifice plate 52 with an array of orifice openings 53. The orifice plate 52 is mounted on a manifold 54, attached to a collar 56. The inkjet printhead 44 is controlled by electrical signals conveyed by flexprint elements 60 that are in electrical communication with controller 46 of print module 14.

Referring particularly to FIG. 7, in operation, ink flows from a reservoir (not shown) into a passage 72. The ink is then conveyed through passage 76 to a pressure chamber 77 from which it is ejected on demand through an orifice passageway 80 and a corresponding orifice 53 in the orifice plate 52 in response to selective actuation of an adjacent portion 82 of a piezoelectric actuator plate 84. Commercial inkjet printheads are available from Spectra, Inc., Hanover, N.H.

Generally, suitable inks include colorants, polymerizable materials, e.g., monomers and/or oligomers, and photoinitiating systems. The polymerizable materials can be cross-linkable.

Colorants include pigments, dyes, or combinations thereof. In some implementations, inks include less than about 10 percent by weight colorant, e.g., less than 7.5 percent, less than 5 percent, less than 2.5 percent or less than 0.1 percent.

The pigment can be black, cyan, magenta, yellow, red, blue, green, brown, or a mixture these colors. Examples of suitable pigments include carbon black, graphite and titanium dioxide. Additional examples are disclosed in, e.g., U.S. Pat. No. 5,389,133.

Alternatively or in addition to the pigment, the inks can contain a dye. Suitable dyes include, e.g., Orasol Pink 5BLG, Black RLI, Blue 2GLN, Red G, Yellow 2GLN, Blue GN, Blue BLN, Black CN, and Brown CR, each being available from Ciba-Geigy. Additional suitable dyes include Morfast Blue 100, Red 101, Red 104, Yellow 102, Black 101, and Black 108, each being available from Morton Chemical Company. Other examples include, e.g., those disclosed in U.S. Pat. No. 5,389,133.

Mixtures of colorants may be employed.

Generally, the inks contain a polymerizable material, e.g., one or more polymerizable monomers. The polymerizable monomers can be mono-functional, di-functional, tri-functional or higher functional, e.g., penta-functional. The mono-, di- and tri-functional monomers have, respectively, one, two, or three functional groups, e.g., unsaturated carbon-carbon groups, which are polymerizable by irradiating in the presence of photoinitiators. In some implementations, the inks include at least about 40 percent, e.g., at least about 50 percent, at least about 60 percent, or at least about 80 percent by weight polymerizable material. Mixtures of polymerizable materials can be utilized, e.g., a mixture containing mono-functional and tri-functional monomers. The polymerizable material can optionally include diluents.

Examples of mono-functional monomers include long chain aliphatic acrylates or methacrylates, e.g., lauryl acrylate or stearyl acrylate, and acrylates of alkoxylated alcohols, e.g., 2-(2-ethoxyethoxy)-ethyl acrylate.

The di-functional material can be, e.g., a diacrylate of a glycol or a polyglycol. Examples of the diacrylates include the diarylates of diethylene glycol, hexanediol, dipropylene glycol, tripropylene glycol, cyclohexane dimethanol (Sartomer CD406), and polyethylene glycols.

Examples of tri- or higher functional materials include tris(2-hydroxyethyl)-isocyanurate triacrylate (Sartomer SR386), dipentaerythritol pentaacrylate (Sartomer SR399), and alkoxylated acrylates, e.g., ethoxylated trimethylolpropane triacrylates (Sartomer SR454), propoxylated glyceryl triacrylate, and propoxylated pentaerythritol tetraacrylate.

The inks may also contain one or more oligomers or polymers, e.g., multi-functional oligomers or polymers.

In some instances, the viscosity of the ink is between about 1 centipoise and about 50 centipoise, e.g., from about 5 centipoise to about 45 centipoise, or from about 7 centipoise to about 35 centipoise, at a temperature ranging from about 20° C. to about 150° C.

A photoinitiating system, e.g., a blend, in the inks is capable of initiating polymerization reactions upon irradiation, e.g., ultraviolet light irradiation.

The photoinitiating system can include, e.g., an aromatic ketone photoinitiator, an amine synergist, an alpha-cleavage type photoinitiator, and/or a photosensitizer. Each component is fully soluble in the monomers and/or diluents described above. Specific examples of the aromatic ketones include, e.g., 4-phenylbenzophenone, dimethyl benzophenone, trimethyl benzophenone (Esacure TZT), and methyl O-benzoyl benzoate.

An amine synergist can be utilized. For example, the amino synergist can be a tertiary amine. Specific examples of the amine synergists include, e.g., 2-(dimethylamino)-ethyl benzoate, ethyl-4-(dimethylamino) benzoate, and amine functional acrylate synergists, e.g., Sartomer CN384, CN373.

An alpha-cleavage type photoinitiator can be an aliphatic or aromatic ketone. Examples of the alpha-cleavage type photoinitiators include, e.g., 2,2-dimethoxy-2-phenyl acetophenone, 2,4,6-trimethylbenzoyl-diphenylphosphine oxide, and 2-methyl-1-[4-(methylthio)phenyl-2-morpholino propan-1-one (Irgacure 907).

A photosensitizer can be a substance that either increases the rate of a photoinitiated polymerization reaction or shifts the wavelength at which the polymerization reaction occurs. Examples of photosensitizers include, e.g., isopropylthioxanthone (ITX), diethylthioxanthone and 2-chlorothioxanthone.

The inks may contain an adjuvant such as a vehicle (e.g., a wax or resin), a stabilizer, an oil, a flexibilizer, or a plasticizer. The stabilizer can, e.g., inhibit oxidation of the ink. The oil, flexibilizer, and plasticizer can reduce the viscosity of the ink.

Examples of waxes include, e.g., stearic acid, succinic acid, beeswax, candelilla wax, carnauba wax, alkylene oxide adducts of alkyl alcohols, phosphate esters of alkyl alcohols, alpha alkyl omega hydroxy poly (oxyethylene), allyl nonanoate, allyl octanoate, allyl sorbate, allyl tiglate, bran wax, paraffin wax, microcrystalline wax, synthetic paraffin wax, petroleum wax, cocoa butter, diacetyl tartaric acid esters of mono and diglycerides, alpha butyl omega hydroxypoly(oxyethylene)poly(oxypropylene), calcium pantothenate, fatty acids, organic esters of fatty acids, amides of fatty acids (e.g., stearamide, stearyl stearamide, crucyl stearamide (e.g., Kemamide S-221 from Crompton-Knowles/Witco), calcium salts of fatty acids, mono & diesters of fatty acids, lanolin, polyhydric alcohol diesters oleic acids, palmitic acid, d-pantothenamide, polyethylene glycol (400) dioleate, polyethylene glycol (MW 200-9,500), polyethylene (MW 200-21,000); oxidized polyethylene; polyglycerol esters of fatty acids, polyglyceryl phthalate ester of coconut oil fatty acids, shellac wax, hydroxylated soybean oil fatty acids, stearyl alcohol, and tallow and its derivatives.

Examples of resins include, e.g., acacia (gum arabic), gum ghatti, guar gum, locust (carob) bean gum, karaya gum (sterculia gum), gum tragacanth, chicle, highly stabilized rosin ester, tall oil, manila copais, corn gluten, coumarone-indene resins, crown gum, damar gum, dimethylstyrene, ethylene oxide polymers, ethylene oxide/propylene oxide copolymer, heptyl paraben, cellulose resins, e.g., methyl and hydroxypropyl; hydroxypropyl methylcellulose resins, isobutylene-isoprene copolymer, polyacrylamide, functionalized or modified polyacrylamide resin, polyisobutylene, polymaleic acid, polyvinyl acetate, polyvinyl alcohol, polyvinyl pyrrolidone, rosin, pentaerythritol ester, purified shellac, styrene terpolymers, styrene copolymers, terpene resins, turpentine gum, zanthun gum and zein.

Examples of stabilizers, oils, flexibilizers and plasticizers include, e.g., methylether hydroquinone (MEHQ), hydroquinone (HQ), butylated hydroxyanisole (BHA), butylated hydroxytoluene (BHT), propyl gallate, tert-butyl hydroquinone (TBHQ), ethylenediaminetetraacetic acid (EDTA), methyl paraben, propyl paraben, benzoic acid, glycerin, lecithin and modified lecithins, agar-agar, dextrin, diacetyl, enzyme modified fats, glucono delta-lactone, carrot oil, pectins, propylene glycol, peanut oil, sorbitol, brominated vegetable oil, polyoxyethylene 60 sorbitan monostearate, olestra, castor oil; 1,3-butylene glycol, coconut oil and its derivatives, corn oil, substituted benzoates, substituted butyrates, substituted citrates, substituted formats, substituted hexanoates, substituted isovalerates, substituted lactates, substituted propionates, substituted isobutyrates, substituted octanoates, substituted palmitates, substituted myristates, substituted oleates, substituted stearates, distearates and tristearates, substituted gluconates, substituted undecanoates, substituted succinates, substituted gallates, substituted phenylacetates, substituted cinnamates, substituted 2-methylbutyrates, substituted tiglates, paraffinic petroleum hydrocarbons, glycerin, mono- and diglycerides and their derivatives, polysorbates 20, 60, 65, 80, propylene glycol mono- and diesters of fats and fatty acids, epoxidized soybean oil and hydrogenated soybean oil.

Additional inks have been described by Woudenberg in Published U.S. Patent Application No. 2004/0132862.

Referring to FIGS. 2-4, various methods of conveying, mixing and/or heating the ink(s) can be employed, e.g., heating can be accomplished with RF energy, microwaves, ultrasound, PTC thermistors or resistive heating elements. In a particular embodiment, a plurality of PTC thermistors are utilized so that the heating of the ink is performed progressively as it is conveyed through the ink pathway 18. In another embodiment, a substantially linear or coiled concentric resistance heating wire (not shown) can extend along the length of the ink pathway 18 in the heating region. The ink can also be heated using frictional heating or by chemical means, e.g., chemical agents added to the ink stream can react with the ink to generate heat. Heat is generated by bond-breaking or bond formation. Suitable chemical agents include metals or salts. In some implementations, high intensity, focus ultrasonic probes can be employed as heat sources for heating the ink as it is conveyed through the ink pathway. Ultrasonic probes can also be used advantageously to mix and emulsify the ink, e.g., to improve the color-blending. Suitable ultrasonic probes have been described in U.S. Pat. Nos. 5,573,497, 5,743,863 and 6,626,855.

A number of embodiments have been described. Nevertheless, it will be understood that various modifications may be made without departing from the spirit and scope of the invention. For example, while embodiments described above with respect to FIGS. 1-4 utilize only two color mixing, other embodiments can utilize ink supply systems in which more than two colors of ink are conveyed and mixed, e.g., three, four, five, six, seven or more, for multi-color blending and printing to the substrate. Accordingly, other embodiments are within the scope of the following claims.

1-65. (canceled)

66. A method of mixing inks, the method comprising:
conveying a predetermined volume of a first ink along a first conduit from a first ink supply to an ink pathway;
conveying a predetermined volume of a second ink along a second conduit to the ink pathway;
conveying the first and second inks through the ink pathway to a print head; and
mixing the first ink and the second ink together as they are conveyed through the ink pathway, thereby forming a mixed ink upstream of the print head.

67. The method of claim 66, further comprising heating the mixed ink in the ink pathway.

68. The method according to claim 66, wherein the first ink comprises solid granules and the second ink comprises solid granules, and wherein heating the mixed ink comprises melting the solid granules of the first and second inks.

69. The method according to claim 66, wherein the first ink comprises solid granules including a first colorant, and the second ink comprises solid granules including a second colorant different from the first colorant, and wherein heating the mixed ink comprises melting the solid granules of the first and second inks to achieve a blended color.

70. The method according to claim 66, wherein at least one of the first and second inks further comprises a microwave energy absorbing material, and further comprising heating the mixed ink with microwave energy.

71. The method according to claim 66, further comprising heating the mixed ink with ultrasound.

72. The method according to claim 66, further comprising heating the mixed ink with a thin-walled heat exchanger.

73. The method according to claim 66, further comprising heating the mixed ink with microwave energy.

74. The method according to claim 66, further comprising heating the mixed ink with a PTC thermistor.

75. The method according to claim 66, further comprising heating the mixed ink by addition of a chemical material to at least one of the first and second inks.

76. The method according to claim 66, wherein the ink includes an electrically conductive material, and further comprising heating the mixed ink using an electrical current.

77. The method according to claim 66, further comprising heating the mixed ink with a moving heat source.

78. The method according to claim 66, further comprising heating the mixed ink with a resistive material.

79. The method according to claim 66, further comprising heating the mixed ink with a fluid directed proximate the ink pathway.

80. The method according to claim 66, further comprising heating the mixed ink by friction.

81. The methods according to claim 1, further comprising progressively heating the mixed ink such that a temperature of the ink increases as the ink travels through the ink pathway.

82. The method of claim 1, wherein the first ink comprises a first colorant and the second ink comprises a second colorant different from the first colorant, and wherein the mixing first and second inks comprises mixing the first and second inks in proportionate volumes to achieve a predetermined color.

83. The method of claim 1, further comprising conveying the first ink along the first conduit with vacuum pressure.

84. The method of claim 1, further comprising conveying the first and second inks through the ink pathway with vacuum pressure.

85. The method of claim 1, further comprising conveying the first and second inks through the ink pathway pneumatically.

86. The method of claim 1, wherein the first ink is conveyed peristaltically.

87. The method of claim 1, wherein the first ink is conveyed by gravity.

88. The method of claim 1, wherein the first ink is conveyed by a thermal gradient.

89. The method of claim 1, wherein at least one of the first and second inks comprises a radiation-curable material.

90. The methods or system of claim 89, wherein the radiation that cures the radiation-curable material is ultra-violet light.

91. The methods or system of claim 89, wherein the radiation that cures the radiation-curable material is visible light.

92. The method of claim 89, wherein the radiation that cures the radiation-curable material is provided by an electron beam device.

93. The methods or system of claim 89, wherein the radiation-curable material comprises a cross-linkable material.

94. An ink supply system comprising:
a first ink supply module configured to store a first ink;
a second ink supply module configured to store a second ink;
an ink pathway configured to transfer predetermined volumes of the first and second inks from the first and second ink supply modules to a print head, wherein the ink pathway is configured to mix the predetermined volumes of the first and second inks, as they are transferred to the print head, to form a mixed ink prior to jetting.

95. The ink supply system according to claim 94, wherein the ink pathway comprises a first portion configured to maintain the mixed ink below a first temperature.

96. The ink supply system according to claim 94, wherein the ink pathway further comprises a second portion, downstream of the first portion, configured to heat the mixed ink above the first temperature as the mixed ink is conveyed through the second portion.

97. The ink supply system according to claim 94, further comprising a positive displacement pump configured to deliver the first and second inks from the first and second ink supply modules to the ink pathway.

98. The ink supply system according to claim 94, further comprising a peristaltic pump disposed along or about the ink pathway in a position upstream of the print head and configured to convey the first and second inks towards the print head.

99. The ink supply system according to claim 94, further comprising a recirculating ball chain disposed along the ink pathway and configured to convey the first and second inks towards the print head.

100. The ink supply system according to claim 94, further comprising a static mixer disposed along the ink pathway and configured to induce mixing of the first and second inks as they are transferred towards the print head.

101. The ink supply system according to claim 94, further comprising an auger disposed along the ink pathway in a position upstream of the print head, said auger being configured for rotation about a longitudinal axis extending along the ink pathway, thereby to convey the first and second inks towards the print head.

102. The ink supply system according to claim 94, further comprising a check valve disposed along the ink pathway and configured to control a flow of a least one of the first and second inks towards the print head.

103. The ink supply system according to claim 94, wherein at least one of the first and second ink supply modules comprises a piston-cylinder positive displacement mechanism.

104. The ink supply system according to claim 94, wherein the ink pathway is permeable to air.
